(19) United States
(12) Patent Application Publication
(10) Pub. No.: US 2021/0315204 A1
(43) Pub. Date: Oct. 14, 2021

(54) LOW-FOAM ADJUVANT COMBINATION FOR FORMULATIONS FOR CROP PROTECTION

(71) Applicant: Bayer Aktiengesellschaft, Leverkusen (DE)

(72) Inventors: Yoshitaka SATO, Yuki City (JP); Hiroko OBATA, Yuki City (JP)

(21) Appl. No.: 17/265,450

(22) PCT Filed: Jul. 30, 2019
(86) PCT No.: PCT/EP2019/070409

§ 371 Date: Feb. 2, 2021

(30) Foreign Application Priority Data
Jul. 30, 2018 (JP) PCT/JP2018/028440

(51) Int. Cl. A01N 25/22; B01D 19/04; A01N 25/30; A01N 25/04; A01N 55/00; A01N 37/12

(52) U.S. Cl. CPC A01N 25/22; B01D 19/0409; A01N 37/12; A01N 25/04; A01N 55/00; A01N 25/30

(57) ABSTRACT

The invention relates to the technical field of adjuvant combinations with antifoam properties (antifoam adjuvant combinations) for crop protection formulations, in particular herbicidal formulations, and formulations containing said adjuvant combinations, as well as methods for producing said formulations.

In a preferred embodiment, the instant invention relates to aqueous formulations of water-soluble active crop protectant ingredients, in particular aqueous formulations of saltlike active crop protectant ingredients, and especially to formulations containing

The invention relates to the technical field of adjuvant combinations with antifoam properties (antifoam adjuvant combinations) for crop protection formulations, in particular herbicidal formulations, and formulations containing said adjuvant combinations, as well as methods for producing said formulations.

In a preferred embodiment, the instant invention relates to aqueous formulations of water-soluble active crop protectant ingredients, in particular aqueous formulations of saltlike active crop protectant ingredients, and especially to formulations containing glufosinate and or glyfosate.

In the following antifoam adjuvants are also named defoamers.

Various and high concentrations of surfactants and adjuvants in agrochemical formulations, in particular in formulations containing water soluble active ingredients like Glufosinate-ammonium or Glyphosate-salts, can provide good spreadability and good retention of sprayed droplet on leaves, improvement or acceleration of penetration into leaf to transport Glufosinate-ammonium or Glyphosate salts into target site and then to ensure reliable herbicidal activity. On the other hands, these surfactants and adjuvants cause problematic foam at the time of preparation/dilution of the spray solution and during the manufacturing and filling process of said formulations.

Aqueous formulations of glufosinate-ammonium are known, for example, from EP-A-0048436, EP-A-00336151, and EP-A-1093722. Because of the surfactants that are present in the formulations and boost the activity, the formulations exhibit unfavorable foam behavior when diluted with water prior to application, and during spraying in the course of application, unless defoamers are added. The consequences then are often overflow of spray apparatus, contamination of the environment, uneven spray deposits on the crops, and crop protectant residues in the spray apparatus.

To suppress or reduce the foam in agrochemical formulations, the use of various antifoams like perfluoroalkyl phosphonic acid (PFPA) or perfluoroalkyl phosphinic acid (PFPIA) or their mixture (prior art 1 EP 0407874 B1) and silicone oil based antifoam (US 2005/0266998 A1) are known.

The known fluorinated defoamers, e.g. PFPA and PFPIA, however, are not equally suitable for all fields of application. In the case of many such formulations, for example, the defoaming activity is dependent on the hardness of the water (the calcium and magnesium salt content) used to prepare the spray liquors.

However, PFPA and PFPIA are similar to perfluorinated alkyl acids (PFAA)—such as perfluorooctane acid (PFOA) or perfluorooctane sulfonic acid (PFOS)—which are considered to have harmful environmental effects. Therefore, from general ecotoxicological considerations the production and use of these PFPA and PFPIA are now restricted.

Hence, there is a need for alternative defoamers which allow the preparation of low-foam formulations of active crop protectant ingredients with good performance properties: for example, good stability on storage and high, uniform biological activity. Moreover, an object of the present invention is to reduce the amount of silicone based defoamer in the formulation.

Silicone oil based antifoams or their formulation, which show excellent defoaming performance, are widely used in various pesticide formulations. However, defoaming performance in aqueous solutions which contain high contents of surfactants and adjuvants, in particular those of polar crop protectant ingredients, especially saltlike ingredients such as glufosinate-ammonium or glyphosate-salts, is insufficient and inferior to PFPA and PFPIA, in particular when hardness of water that is used to make a spray solution is high.

Further, it is difficult to disperse silicone oil in water based formulation to obtain stable formulation for long storage/shelf life (more than 1 year), wherein stable means no phase separation and gel forming.

Further, defoamers of this kind no longer exhibit a sufficient defoamer activity after the formulations having been stored at room temperature or at an elevated temperature with up to 50° C., for example.

To overcome this problem organic solvent based formulations were prepared, but the antifoam performance still seem to be insufficient (WO 2004/105914 A1).

In addition, replacing the defoamers (antifoam adjuvant) in many known crop protectant compositions by other defoamers is found from experience, and in accordance with our own experiments, to lead in many cases to a marked reduction in the biological activity of the formulations.

The object is therefore to provide a defoaming combination for formulations of agrochemicals, in particular aqueous formulations of saltlike water-soluble crop protectants, that eliminate or reduce the aforementioned disadvantages and can be used with one or more advantages.

Surprisingly it has now been found that the perfluorated antifoam agents can be replaced be a defoamer composition comprising a fatty acid ester and a silicone based antifoam, wherein the fatty acid ester has the higher proportion than the silicone based antifoam and preferably the fatty acid ester has an acid moiety (carboxylic acid moiety) comprising 8 to 16 C-atoms.

In the present invention the term “fatty acid ester” relates to a carboxylic ester composed of a carboxylic acid moiety and an alcohol moiety as depicted in formula I

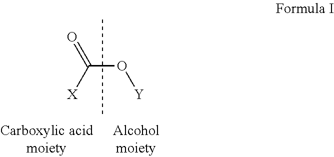

wherein said carboxylic ester has a C8-C16 carboxylic acid moiety.

In connection with the present invention, the carboxylic ester may either be isolated from natural sources or produced by any method known in the art which is not limited to esterification of the respective carboxylic acid and alcohol underlying the carboxylic acid moiety and the alcohol moiety according to Formula I. Rather, usage of the terms “carboxylic acid moiety” and “alcohol moiety” serves to clarify and define the structure of the carboxylic esters according to the invention. When combined, both moieties create an ester group under formal elimination of H₂O. Accordingly, the carboxylic acid moiety may as well be defined as the X—(C═O)— radical of a carboxylic acid, and the alcohol moiety may be defined as the Y—O— radical of an alcohol. Such definition is also referred to as “derived from” in connection with the present invention. Preferably, the carboxylic acid underlying the carboxylic acid moiety is a carboxylic monoacid as defined further below and the alcohol underlying the alcohol moiety is a monoalcohol or a polyalcohol as defined further below.

Therefore, in one aspect of the present invention the defoaming composition for agrochemical formulation comprises:

1) an silicone based defoamer, and
2) a fatty acid ester (carboxylic ester) with a C8 to C16, preferably C8-C9, acid moiety.

Preferably the ratio of 1) to 2) is from 1:1000 to 1:8, more preferred, from 1:500 to 1:8, even more preferred from 1:200 to 1:9, and further preferred from 1:100 to 1:10, and most preferred from 1:50 to 1:10.

In one embodiment the ratio of 1) to 2) is from 1:20 to 1:10.

If not otherwise indicated ratio of defoamer 1) to fatty acid ester 2) always is weight ratio.

The defoamers 1) according to the present the invention comprise defoamers from the group consisting of linear polydimethylsiloxanes. Preferably, the defoamers have an average dynamic viscosity, measured at 25° C., in the range from 1000 to 8000 mPas (mPas=millipascal-second), preferably 1000 to 6000 mPas. The viscosity can be measured by a rotational shear rheometer, e.g. with a Brookfield RVT viscometer, needle no. 3, 20 rpm, in accordance with the ISO 2555 standard.

Further, in another embodiment, the said defoamers additionally contain silica. By silica is meant, for example, forms/modifications such as polysilicic acids, meta-silicic acid, ortho-silicic acid, silica gel, silicic acid gels, kieselguhr, precipitated SiO₂ etc.

Defoamers from the group of the linear polydimethylsiloxanes include as their chemical backbone a compound of the formula HO—[Si(CH₃)₂—O-]ₙ—H, in which the end groups are modified—etherified, for example—or, in general, are joined to the groups —Si(CH₃)₃.

The amount of silica can be modified within a wide range and is generally in the range from 0.1 to 10 percent by weight, preferably 0.2 to 5 percent by weight, in particular 0.2% to 2% by weight of silica, based on the weight of polydimethylsiloxane.

Examples of defoamers of this kind are ®Rhodorsil Antifoam 416 (Rhodia) and ®Rhodorsil Antifoam 481 (Rhodia).

®Rhodorsil Antifoam 416 is a medium-viscosity silicone oil having a dynamic viscosity at 25° C. of about 1500 mPas and containing a surfactant and silica. Because of the surfactant content the density is reduced as compared with the unadditized silicone oil, and amounts to about 0.995 g/cm³.

®Rhodorsil Antifoam 481 is a medium-viscosity silicone oil having a dynamic viscosity at 25° C. of about 4500 mPas and containing silica. The density amounts to about 1.045 g/cm³.

The silicone oils can also be used as emulsions, e.g SAG 1572 Silicone Antifoam Emulsion by Momentive, Antifoam EM SE 39 (silicone-based defoamer emulsion without silica gel, Wacker), Antimussol 4459-2 (silicone-based defoamer emulsion without silica gel, Clariant), Rhodorsil 1824 (silicone-based defoamer emulsion without silica gel, Rhodia).

Preference is given to the use of medium-viscosity defoamers based on polydimethylsiloxanes having a dynamic viscosity, measured at 25° C., in the range from 1000 to 5000 mPas, preferably 1200 to 5000 mPas, in particular emulsion defoamers like ®SAG 1572.

In one embodiment, said at least one fatty acid ester 2) is composed of or contains or may be obtained from
a1) a carboxylic monoacid moiety and a monoalcohol moiety and/or
b1) at least one carboxylic monoacid moiety and a polyalcohol moiety
   wherein said monoalcohol moiety is a branched, linear, cyclic, acyclic or partially cyclic, saturated or partially unsaturated C1-C24 monoalcohol moiety, preferably;
   wherein said polyalcohol moiety is a branched, linear, cyclic, acyclic or partially cyclic, saturated or partially unsaturated di-, tri-, tetra-, penta- and/or hexavalent C2-C20 polyalcohol moiety; and
   wherein said carboxylic monoacid moiety is a branched, linear, cyclic, acyclic or partially cyclic, saturated or partially unsaturated C8-C16 carboxylic monoacid moiety, preferably C8-C9 carboxylic monoacid moiety optionally carrying at least one OH functionality.

As known to the skilled artisan branched moieties have to have at least 3 carbon atoms.

In one embodiment, any one of a1) and or b1) is a mixture of esters comprised of more than one different monoalcohol, polyalcohol or carboxylic monacid. For example, the mixture according to a1) may comprise more than one different carboxylic monoacid and/or monoalcohol moiety, and/or the mixture according to b1) may comprise more than one different carboxylic monoacid and/or polyalcohol moiety.

In a preferred embodiment, said monoalcohol moiety is derived from a branched, linear, saturated or partially unsaturated C1-C20 monoalcohol, preferably from a C4-12 monoalcohol, even more preferred from a C6-C10 monoalcohol and most preferred from C8-C9 monoalcohol.

Further preferred the monoalcohol is a branched monoalcohol.

Exemplary and preferred monoalcohols are selected from the group consisting of methanol, ethanol, 1-propanol, 2-propanol, 1-butanol, 2-butanol, isobutanol, tert-butanol, 1-pentanol, 1-hexanol, 1-heptanol, 2-ethylhexan-1-ol, 3,5,5-trimethylhexan-1-ol, 3,4,4-trimethylpentan-1-ol, capryl alcohol, pelargonic alcohol, isononyl alcohol, capric alcohol, undecanol, lauryl alcohol, and optionally mixtures of any of the foregoing. More preferred monoalcohols comprise 1-propanol, 2-propanol, 1-butanol, 2-butanol, isobutanol, tert-butanol, 1-pentanol, 1-hexanol, 1-heptanol, 2-ethylhexan-1-ol, 3,5,5-trimethylhexan-1-ol, 3,4,4-trimethylpentan-1-ol, capryl alcohol, pelargonic alcohol, isononyl alcohol, capric alcohol, and optionally mixtures of any of the foregoing.

Even more preferred monoalkohols comprise 2-propanol, 2-butanol, isobutanol, tert-butanol, 1-pentanol, 1-hexanol, 1-heptanol, 2-ethylhexan-1-ol, 3,5,5-trimethylhexan-1-ol, 3,4,4-trimethylpentan-1-ol, capryl alcohol, and optionally mixtures of any of the foregoing.

Most preferred monoalkohols comprise 2-ethylhexan-1-ol, 3,5,5-trimethylhexan-1-ol, 3,4,4-trimethylpentan-1-ol, capryl alcohol, and optionally mixtures of any of the foregoing.

In another preferred embodiment, said at least one carboxylic monoacid moiety is derived from a branched, linear, saturated or partially unsaturated C8-C16 carboxylic monoacid, preferably from a C8-C9 carboxylic monoacid. Exemplary and preferred carboxylic monoacids comprise, caprylic acid, capric acid, 2-ethylhexanoic acid, 3,5,5-trimethylhexanoic acid, 3,4,4-trimethylpentanoic acid, lauric acid, myristic acid, palmitic acid, and optionally mixtures of any of the foregoing.

More preferred the carboxylic monoacids comprise caprylic acid, 2-ethylhexanoic acid, 3,5,5-trimethylhexanoic acid, 3,4,4-trimethylpentanoic acid and palmitic acid.

Most preferred the carboxylic monoacids comprise caprylic acid, 2-ethylhexanoic acid, 3,5,5-trimethylhexanoic acid and 3,4,4-trimethylpentanoic acid.

In a preferred embodiment, the at least one polyalcohol moiety is derived from a polyalcohol selected from the group consisting of glycol, 1,3-propandiol, 1-4-butandiol, 1,5-pentandiol, 1,6-hexandiol, cyclohexan-1,2-diol, isosorbid, 1,2-propandiol, neopentylglycol, glycerol, trimethylolpropane, erythritol, pentaerythritol and sugar alcohols according to the formula HOCH₂(CHOH₎CH₂OH and optionally mixtures thereof. Examples of sugar alcohols comprise ethylene glycol, glycerol, erythrol, threitol, arabitol, xylitol, ribitol, mannitol, sorbitol, galactitol, fucitol, iditol, inositol, volemitol, isomalt, maltitol, lactitol, maltotriol, maltotetraitol, polyglycitol and sorbitan. Preferred sugar alcohols are sorbitol and sorbitan.

More preferred polyalcohols are 1,2-propandiol, erythritol, neopentylglycol, glycerol, 1,3-propandiol, trimethylolpropane and sorbitan and optionally mixtures thereof.

Most preferred polyalcohols are erythritol, neopentylglycol, glycerol.

The at least one polyalcohol giving rise to the polyalcohol moiety as comprised in certain embodiments of said at least one carboxylic ester according to b1) may be partially or fully esterified. In other words, the polyalcohol may be esterified at one or more of its functional OH groups up to all functional OH groups present in the resulting polyalcohol moiety. Accordingly, in a polyalcohol moiety comprising three functional OH groups, such as glycerol, one or two or all three OH groups may be esterified with a monoacid to form a carboxylic ester according to b1).

Particularly preferred carboxylic esters according to a1) comprise a carboxylic monoacid moiety derived from a carboxylic monoacid selected from the group consisting of caprylic acid, 2-ethylhexanoic acid, 3,5,5-trimethylhexanoic acid, 3,4,4-trimethylpentanoic acid and palmitic acid, and optionally mixtures thereof and a monoalcohol moiety derived from a monoalcohol selected from the group consisting of 2-ethylhexan-1-ol, 3,5,5-trimethylhexan-1-ol, 3,4,4-trimethylpentan-1-ol, capryl alcohol, and optionally mixtures thereof.

In a preferred embodiment, said monoalcohol moiety is derived from a branched, linear, saturated or partially unsaturated C1-C20 monoalcohol, preferably from a C4-12 monoalcohol, even more preferred from a C6-C10 monoalcohol and most preferred from C8-C9 monoalcohol.

Preferably, the number of C-atoms in the carboxylic ester according to b) ranges between 9 and 37 carbon atoms, more preferably between 9 and 24 carbon atoms.

Particularly preferred polyalcohol moieties comprised in the carboxylic esters according to b) are derived from are erythritol, neopentylglycol, glycerol, and optionally mixtures thereof, and caprylic acid, 2-ethylhexanoic acid, 3,5,5-trimethylhexanoic acid and, 3,4,4-trimethylpentanoic acid and mixtures thereof.

Especially preferred, the fatty acid ester is selected from the group comprising
3,5,5-trimethylhexyl 3,5,5-trimethylhexanoate,
3,5,5-trimethylhexyl 7-methyloctanoate,
2-ethylhexylpalmitat,
2,3,4-tris(2-ethylhexanoyloxy)butyl 2-ethylhexanoate,
Neopentyl glycol diethylhexanoate, and
1,3-bis[(2-ethylhexanoy)oxy]propan-2-yl2-ethylhexanoate.

In one embodiment the fatty acid ester is selected from the group comprising
3,5,5-trimethylhexyl 3,5,5-trimethylhexanoate and
3,5,5-trimethylhexyl 7-methyloctanoate.

In another embodiment the fatty acid ester is selected from the group comprising
2,3,4-tris(2-ethylhexanoyloxy)butyl 2-ethylhexanoate,
Neopentyl glycol diethylhexanoate, and
1,3-bis[(2-ethylhexanoy)oxy]propan-2-yl2-ethylhexanoate.

In another aspect, the instant invention provides liquid aqueous crop protectant compositions, preferably of water-soluble active crop protectant ingredients, said compositions comprising
(a) one or more water-soluble active crop protectant ingredients (type (a) active ingredients),
(b) optionally one or more water-insoluble active crop protectant ingredients (type (b) active ingredients),
(c) optionally polar organic solvents,
(d) anionic surfactants,
(e) optionally, nonionic, cationic and/or zwitterionic surfactants,
(f) silicone-based defoamers 1) as described above.
(g) fatty acid ester 2) as described above
(h) if desired, other customary formulation assistants, and
(i) water,
   wherein the ratio of f (silicone-based defoamer 1)) to g) (fatty acid ester 2)) is from 1:1000 to 1:8, more preferred, from 1:500 to 1:8, even more preferred from 1:200 to 1:9, and further preferred from 1:100 to 1:10, and most preferred from 1:50 to 1:10.

In a preferred embodiment (f) is selected from the group of the linear polydimethylsiloxanes having an average dynamic viscosity, measured at 25° C., in the range from 1000 to 8000 mPas.

In a further preferred embodiment (f) is of the emulsion type.

In another embodiment (f) contains silica.

The aqueous formulations of the invention, containing defoamer, are suitable preferably for type (a) active ingredients from the group of the salt-containing water-soluble active ingredients such as glufosinate (salts), glyphosate (salts), paraquat, diquat and the like, especially glufosinate-ammonium and glyphosate salts.

The formulations of the invention may further comprise type (b) active ingredients, which are largely insoluble in water, examples being herbicides from the group of the diphenyl ethers such as oxyfluorfen, carbamates, thiocarbamates, triphenyltin compounds and tributyltin compounds, haloacetanilides, phenoxyphenoxyalkanecarboxylic acid derivatives and heteroaryloxyphenoxyalkanecarboxylic acid derivatives, such as quinolyloxy quinoxalyloxy pyridyloxy benzoxalyloxy- and benzothiazolyloxyphenoxyalkanecarboxylic esters, examples being diclofop-methyl, fenoxaprop-ethyl, and fenoxaprop-P-ethyl.

Also suitable are correspondingly insoluble active ingredients from classes of substance which normally include active ingredients of different solubilities, examples being active ingredients from the group of the cyclohexanedione derivatives, imidazolinones, pyrimidyloxypyridinecarboxylic acid derivatives, pyrimidyloxybenzoic acid derivatives, sulfonylureas, triazolopyrimidinesulfonamide derivatives, and S—(N-aryl-N-alkylcarbamoylmethyl)dithiophosphoric esters.

The stated common names for active ingredients, such as glufosinate, glyphosate, oxyfluorfen, diclofop-methyl, fenoxaprop-(P-)ethyl and others, are known to the skilled worker; see, for example, “The Pesticide Manual” British Crop Protection Council 2003; the names include the known derivatives such as salts of glufosinate and glyphosate, especially the commercially customary forms.

Correspondingly it is also possible for active ingredients from the group of the safeners, growth regulators, insecticides and fungicides to be suitable as component (b) and/or, given good water-solubility, as components (a).

The type of active ingredients (a) and (b) used determine the type of pests which can be controlled by application of the crop protection compositions or agrochemical formulations. In case of herbicides the pests are undesired plants.

Preferred formulations are those comprising type (a) ingredients from the group consisting of one or more compounds of the formula (1) or salts thereof,

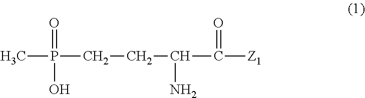

in which
Z₁ is a radical of the formula —OM, —NHCH(CH₃)CONHCH(CH₃)CO₂M or —NHCH(CH₃)CONHCH[CH₂CH(CH₃)₂]CO₂M where
M=H or a salt-forming cation,
and/or one or more compounds of the formula (2) or salts thereof,

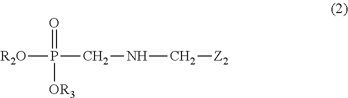

in which
Z₂ is a radical of the formula CN or CO₂R₁, in which R₁=Q or a salt-forming cation and Q=H, alkyl, alkenyl, alkoxyalkyl or C₆-C₁₀-aryl which is unsubstituted or substituted and is preferably unsubstituted or substituted by one or more radicals from the group consisting of alkyl, alkoxy, halogen, CF₃, NO₂ and CN, and

R₂ and R₃ each independently of one another are H, alkyl, C₆-C₁₀-aryl which is unsubstituted or substituted and is preferably unsubstituted or substituted by one or more radicals from the group consisting of alkyl, alkoxy, halogen, CF₃, NO₂ and CN, or are biphenylyl or a salt-forming cation.

Preferably, the carbon-containing radicals in connection with Q, R₂ or R₃, respectively have up to 10 carbon atoms, particularly preferred up to 6 carbon atoms.

The compounds of the formula (1) include an asymmetric carbon atom. The L enantiomer is regarded as the biologically active isomer. The formula (1) hence embraces all stereoisomers and mixtures thereof, particularly the racemate, and the biologically active enantiomer in each case. Examples of active ingredients of the formula (1) are as follows:
glufosinate and its ammonium salt in racemic form, i.e., 2-amino-4-[hydroxy(methyl)phosphinoyl]butanoic acid and its ammonium salt,
the L enantiomer of glufosinate and its ammonium salt,
bilanafos/bialaphos, i.e., L-2-amino-4-[hydroxy (methyl)phosphinoyl]butanoyl-L-alaninyl-L-alanine and its sodium salt.

The racemate of glufosinate-ammonium is on its own delivered usually at doses of between 200 and 1000 g a.i./ha (i.e., grams of active ingredient per hectare). These doses, glufosinate-ammonium is particularly effective when it is taken up by green parts of the plants; see “The Pesticide Manual” 13th Edition, British Crop Protection Council 2003. Glufosinate-ammonium is used predominantly for controlling broadleaf and gramineous weeds in plantation crops and on uncultivated land and also, using special application techniques, for inter-row control in arable crops such as corn, cotton, etc. Its use is also of increasing significance in transgenic crops which are tolerant or resistant to the active ingredient.

The compounds of the formula (2) comprise N-(phosphonoalkyl)glycine and hence derivatives of the amino acid glycine. The herbicidal properties of N-(phosphonomethyl)glycine (glyphosate) are described for example in U.S. Pat. No. 3,799,758.

In crop protection formulations, glyphosate is used generally in the form of the water-soluble salts, the isopropylammonium salt in particular being of importance in connection with the present invention; see “The Pesticide Manual” 13th Edition, British Crop Protection Council 2003.

In connection with the present invention the term “polar organic solvents” (component (c)) refers for example to polar protic or aprotic polar solvents and mixtures thereof. Examples of solvents in the sense of the invention are
aliphatic alcohols, such as lower alkanols such as methanol, ethanol, propanol, isopropanol and butanol, or polyhydric alcohols such as ethylene glycol, 1-methyl-propanediol and glycerol, for example,
polar ethers such as tetrahydrofuran (THF), dioxane, alkylene glycol monoalkyl and dialkyl ethers, such as propylene glycol monomethyl ether, propylene glycol monoethyl ether, ethylene glycol monomethyl or monoethyl ether, diglyme and tetraglyme, for example;
amides such as dimethylformamide (DMF), dimethylacetamide, dimethylcaprylamide, dimethylcapramide (®Hallcomide) and N-alkylpyrrolidones;
ketones such as acetone;
esters based on glycerol and carboxylic acids, such as glyceryl mono-, di- and triacetate,
lactams;
carbonic diesters;
nitriles such as acetonitrile, propionitrile, butyronitrile and benzonitrile;
sulfoxides and sulfones such as dimethyl sulfoxide (DMSO) and sulfolane.

Also suitable in many cases are combinations of different solvents which additionally include alcohols such as methanol, ethanol, n- and isopropanol, n-, iso-, tert- and 2-butanol.

In the case of single-phase aqueous-organic solutions the wholly or largely water-miscible solvents or solvent mixtures are appropriate.

Preferred organic solvents in the sense of the present invention are polar organic solvents such as N-methylpyrrolidone and Dowanol® PM (propylene glycol monomethyl ether).

Formulations of the invention comprise as component (d) anionic surface-active compounds (anionic surfactants). Examples of anionic surfactants (where EO=ethylene oxide units, PO=propylene oxide units and BO=butylene oxide units) are:
d1) anionic derivatives of fatty alcohols having 10-24 carbon atoms with 0-60 EO and/or 0-20 PO and/or 0-15 BO in any order, in the form of ether carboxylates, sulfonates, sulfates and phosphates and their inorganic (e.g., alkali metal and alkaline earth metal) and organic salts (e.g., those based on amine or alkanolamine), such as Genapol®LRO, Sandopan® grades, Hostaphat/Hordaphos® grades from Clariant;
d2) anionic derivatives of copolymers composed of EO, PO and/or BO units with a molecular weight of 400 to 10⁸, in the form of ether carboxylates, sulfonates, sulfates and phosphates and their inorganic (e.g., alkali metal and alkaline earth metal) and organic salts (e.g., those based on amine or alkanolamine);
d3) anionic derivatives of alkylene oxide adducts of C1-C9 alcohols, in the form of ether carboxylates, sulfonates, sulfates and phosphates and their inorganic (e.g., alkali metal and alkaline earth metal) and organic salts (e.g., those based on amine or alkanolamine);
d4) anionic derivatives of fatty acid alkoxylates in the form of ether carboxylates, sulfonates, sulfates and phosphates and their inorganic (e.g., alkali metal and alkaline earth metal) and organic salts (e.g., those based on amine or alkanolamine);
d5) salts of aliphatic, cycloaliphatic and olefinic carboxylic and polycarboxylic acids, and also alpha-sulfo fatty acid esters as are obtainable from Henkel;
d6) sulfosuccinates, alkanesulfonates, paraffinsulfonates and olefinsulfonates such as Netzer IS®, Hoe S1728, Hostapur®OS, Hostapur®SAS from Clariant, Triton®GRIME and GR5 from Union Carbide, Empimin® grades from Albright and Wilson, and Marlon®-PS65 from Condea.

Preferred anionic surfactants are alkyl polyglycol ether sulfates, especially fatty alcohol diethylene glycol ether sulfate (e.g., Genapol LRO®, Clariant), or alkyl polyglycol ether carboxylates (e.g., 2-(isotridecyloxypolyethyleneoxy)ethyl carboxymethyl ether, Marlowet 4538®, Hüls).

The formulations of the invention may if desired comprise nonionic and/or cationic surfactants as component (e).

Examples of nonionic surfactants (for surfactant component e) are:
e1) fatty alcohols having 10-24 carbon atoms with 0-60 EO and/or 0-20 PO and/or 0-15 BO in any order. Examples of such compounds are Genapol® C, L, O, T, UD, UDD and X grades from Clariant, Plurafac® and Lutensol® A, AT, ON and TO grades from BASF, Marlipal®24 and 013 grades from Condea, Dehypon® grades from Henkel, and Ethylan® grades from Akzo-Nobel such as Ethylan DC 120;
e2) fatty acid alkoxylates and triglyceride alkoxylates such as the Serdox® NOG grades from Condea or the Emulsogen® grades from Clariant;
e3) fatty acid amide alkoxylates such as the Comperlan® grades from Henkel or the Amam® grades from Rhodia;
e4) alkylene oxide adducts of alkynediols such as the Surfynol® grades from Air Products; sugar derivatives such as amino sugars and amido sugars from Clariant,
e5) glucitols from Clariant,
e6) alkylpolyglycosides in the form of the APG® grades from Henkel;
e7) sorbitan esters in the form of the Span® or Tween® grades from Uniqema;
e8) cyclodextrin esters or ethers from Wacker;
e9) surface-active cellulose derivatives and algine, pectin and guar derivatives such as the Tylose® grades from Clariant, the Manutex® grades from Kelco, and guar derivatives from Cesalpina;
e10) polyol-based alkylene oxide adducts such as Polyglykol® grades from Clariant;
e11) surface-active polyglycerides and their derivatives from Clariant.

Examples of cationic surfactants (for surfactant component e) are alkylene oxide adducts of fatty amines and corresponding quaternary ammonium compounds having 8 to 22 carbon atoms such as, for example, the Genamin® C, L, O and T grades from Clariant.

Also possible if desired are surface-active zwitterionic compounds such as taurides, betaines and sulfobetaines in the form of Tegotain® grades from Goldschmidt and Hostapon T and Arkopon T grades from Clariant (for surfactant component e).

In one preferred embodiment, e) is present as in form of alkylpolyglycosides.

The formulations of the invention comprise defoamers of component (f), which is described above as 1).

The formulations of the invention also comprise fatty acid esters (g), which are described above as 2).

Examples of customary formulation assistants (h) are inert materials, such as stickers, wetters, dispersants, emulsifiers, penetrants, preservatives, and frost protectants, fillers, carriers, dyes and colorants, evaporation inhibitors and pH modifiers (buffers, acids and bases) or viscosity modifiers (e.g., thickeners).

The assistants needed to prepare the above formulations, such as surfactants in particular, are known in principle and are described for example in: McCutcheon's “Detergents and Emulsifiers Annual”, MC Publ. Corp., Ridgewood N.J.; Sisley and Wood “Encyclopedia of Surface Active Agents”, Chem. Publ. Co. Inc., N.Y. 1964; Schönfeldt, “Grenzflächenaktive Äthylenoxidaddukte”, Wiss. Verlagsgesellschaft, Stuttgart 1976; Winnacker-Küchler, “Chemische Technologic”, Volume 7, C. Hanser-Verlag, Munich, 4th Edition 1986, and references cited in each of these.

With the aid of mixtures of components it is possible accordingly to prepare preferably concentrated low-foam liquid aqueous preparations of saltlike active crop protectant ingredients, such as glufosinate-ammonium or glyphosate salts, which comprise
(a) 1% to 40%, preferably 2% to 30% and in particular 5% to 20% by weight of water-soluble active crop protectant ingredients (type (a) ingredients),
(b) 0 to 40%, preferably 0 to 20% and in particular 0 to 10% by weight of water-insoluble active crop protectant ingredients (type (b) ingredients),
(c) 0% to 50%, preferably 2 to 30%, more preferably 5 to 20%, and most preferred 5 to 15% by weight of polar organic solvents,
(d) 1% to 80%, preferably 5% to 70%, more preferred 6% to 60%, and most preferred 20 to 40% by weight of anionic surfactants,
(e) 0 to 20%, preferably 0 to 15%, by weight of nonionic, cationic and/or zwitterionic surfactants, (f) 0.0005% to 2%, preferably 0.005% to 1% and in particular 0.01% to 0.25% by weight of the, optionally silica-containing, defoamer for use in accordance with the invention,
(g) 0.01% to 20%, preferably 0.05% to 10% and in particular 0.5% to 5.0% by weight of fatty acid ester for use in accordance with the invention,
(h) 0 to 30%, preferably 0 to 20% and preferably 0.1 to 15% by weight of customary formulation assistants,
(i) water to add up to 100%,
   wherein the ratio of f (silicone-based defoamer 1)) to g) (fatty acid ester 2)) is from 1:1000 to 1:8, more preferred, from 1:500 to 1:8, even more preferred from 1:200 to 1:9, and further preferred from 1:100 to 1:10, and most preferred from 1:50 to 1:10.

In one embodiment b is present in 0.1 to 40% by weight.

In one embodiment e is present in 0.1 to 15% by weight, If not indicated otherwise % in the present application refers to % by weight.

The weight ratio of the active ingredients (a), e.g. herbicides (a), to the anionic surfactants specified under (d), based in each case on the respective detersive ingredient (DTI), is generally in the range from 1:0.1 to 1:10, in particular 1:0.2 to 1:8, especially 1:0.2 to 1:5.

The weight ratio of the active ingredients (a), e.g. herbicides (a), to the defoamers specified under (f) is preferably in the range from 1000:1 to 2:1, more preferably 500:1 to 20:1, in particular 200:1 to 50:1.

The weight ratio of the anionic surfactants (d) to the defoamers specified under (f) is preferably in the range from 1000:1 to 2:1, more preferably 800:1 to 50:1, in particular 500:1 to 50:1.

Further preference is also given to aqueous solutions, preferably single-phase solutions, which comprise
(a) 1% to 40%, preferably 2% to 30% and in particular 5% to 20% by weight of water-soluble active crop protectant ingredients (type (a) ingredients),
(b) 0 to 40%, preferably 0 to 20% and in particular 0 to 10% by weight of water-insoluble active crop protectant ingredients (type (b) ingredients),
(c) 0% to 50%, preferably 2 to 30%, more preferably 5 to 20%, and most preferred 5 to 15% by weight of polar organic solvents,
(d) 1% to 80%, preferably 5% to 70%, more preferred 6% to 60%, and most preferred 20 to 40% by weight of anionic surfactants,
(e) 0 to 20%, preferably 0 to 15%, by weight of nonionic, cationic and/or zwitterionic surfactants,
(f) 0.0005% to 2%, preferably 0.005% to 1% and in particular 0.01% to 0.05% by weight of the, non silica-containing, defoamer for use in accordance with the invention,
(g) 0.01% to 20%, preferably 0.05% to 10% and in particular 0.5% to 5.0% by weight of fatty acid ester for use in accordance with the invention,
(h) 0 to 30%, preferably 0 to 20% and preferably 0.1 to 15% by weight of customary formulation assistants,
(i) water to add up to 100%,

The solvents which can be added for the purpose of preparing the aqueous single-phase solution are in particular organic solvents of unlimited or substantial miscibility with water, such as N-methylpyrrolidone (NMP), N-butylpyrrolidone (NBP), dimethylformamide (DMF), dimethylacetamide (DMA) or Dowanol® PM (propylene glycol monomethyl ether), 1-methyl-propanediol, for example

Examples of customary formulation assistants (g) are the specified inert materials, frost protectants, evaporation inhibitors, preservatives, colorants, etc.; preferred formulation assistants (g) are
frost protectants and evaporation inhibitors such as glycerol or ethylene glycol, in an amount of 2% to 10% by weight, for example, and
preservatives, e.g., Mergal K9N® (Riedel) or Cobate C®.

Additionally the formulations may comprise, as customary formulation assistants (g), defoamers of a different kind than those of component (f) or (g).

The liquid formulations of the invention can be prepared by methods which are customary in principle, i.e., by mixing the components with stirring or shaking or by means of static mixing methods. The liquid formulations obtained are stable with good storage properties.

The invention further provides low-foam liquid adjuvant formulations which can be used for preparing the stated concentrated crop protectant formulations or for preparing tank mixes with active crop protectant ingredient formulations, or else may be applied separately, simultaneously or sequentially with the application of active ingredients (preferably the stated active ingredients (a)) to the plants or to the soil on or in which the plants are growing.

Adjuvant formulations of this kind comprise
(c) optionally polar organic solvents,
(d) anionic surfactants,
(e) optionally, nonionic, cationic and/or zwitterionic surfactants, silicone-based defoamers 1) as described
(g) fatty acid ester 2) as described above
(h) if desired, other customary formulation assistants, and
(i) water,
   components (c), (d), (e), (f), (g) and (h) and ratio of (f) to (g) being as defined for the aforementioned crop protectant formulations comprising active ingredient.

Preferred liquid adjuvant formulations comprise
(c) 0% to 50%, preferably 2 to 30%, more preferably 5 to 20%, and most preferred 5 to 15% by weight of polar organic solvents,
(d) 1% to 80%, preferably 5% to 70%, more preferred 6% to 60%, and most preferred 20 to 40% by weight of anionic surfactants,
(e) 0 to 20%, preferably 0 to 15%, by weight of nonionic, cationic and/or zwitterionic surfactants,
(f) 0.0005% to 2%, preferably 0.005% to 1% and in particular 0.01% to 0.05% by weight of the, optionally silica-containing, defoamer for use in accordance with the invention,
(g) 0.01% to 20%, preferably 0.05% to 10% and in particular 0.5% to 5.0% by weight of fatty acid ester for use in accordance with the invention,
(h) 0 to 30%, preferably 0 to 20% and preferably 0.1 to 15% by weight of customary formulation assistants,
(i) water to add up to 100%,

The liquid formulations comprising active ingredient and the adjuvant formulations are low-foam formulations with good storage properties. In many cases they have very favorable technical properties on application. By way of example the formulations are distinguished by a low tendency to foam when diluted with water, as for example when preparing tank mixes or when the formulations are applied by spraying, as well as rapid degradation of foam. Moreover, the amount of silicone based defoamer can be significantly reduced by adding biodegradable fatty acid esters.

Accordingly the formulations of the invention are especially suitable for use in crop protection where the formulations are applied to the plants, to parts of plants or to the area under cultivation.

In the case of herbicidal ingredients (a) and/or (b) the formulations are very suitable for controlling unwanted plant growth both on uncultivated land and in tolerant crops.

Moreover, the defoaming composition of the instant application can be used for preparing low foam crop protection formulations according to the instant application.

In the tables the columns list the compositions of formulations with each line containing the amount of the component identified in the first column, in percent by weight.

TABLE 1
Formulations

| Example No. | 1 ⁽¹⁾ | 2 | 3 | 4 | 5 | 6 | 7 | 8 |
|---|---|---|---|---|---|---|---|---|
| (a) Glufosinate-ammonium (a.i.) | 18.50 | 18.50 | 18.50 | 18.50 | 18.50 | 18.50 | 18.50 | 18.50 |
| (d) SLES ⁽²⁾ | 30.00 | 30.00 | 30.00 | 30.00 | 30.00 | 30.00 | 30.00 | 30.00 |
| (c) 1-methyl-propanediol | 10.00 | 10.00 | 10.00 | 10.00 | 10.00 | 10.00 | 10.00 | 10.00 |
| (f) silicone based antifoam f1 ⁽³⁾ | 0.01 | 0.03 | 0.05 | 0.1 | 0.15 | 0.25 | 0.05 | 0.05 |
| (g) fatty acid ester g1 ⁽⁴⁾ | 1.00 | 1.00 | 1.00 | 1.00 | 1.00 | 1.00 | 2.00 | 5.00 |
| (i) water⁽⁵⁾ | ad 100 | ad 100 | ad 100 | ad 100 | ad 100 | ad 100 | ad 100 | ad 100 |
| | | 9 | | 11 | | 13 | | 14 |
| (a) Glufosinate-ammonium (a.i.) | | 18.50 | | 18.50 | | 18.50 | | 18.50 |
| (d) SLES ⁽²⁾ | | 30.00 | | 30.00 | | 30.00 | | 30.00 |
| (c) 1-methyl-propanediol | | 10.00 | | 10.00 | | 10.00 | | 10.00 |
| (f) silicone based antifoam f3 ⁽³⁾ | | 0.15 | | 0.10 | | 0.05 | | 0.1 (f2) |
| (g) fatty acid ester g1 ⁽⁴⁾ | | 1.00 | | 1.00 | | 1.00 | | 1.00 |
| (i) water⁽⁵⁾ | | ad 100 | | ad 100 | | ad 100 | | ad 100 |
| Example No. | 10 | 16 | 17 | 18 | 21 | 22 | 23 | 24 |
| (a) Glufosinate-ammonium (a.i.) | 18.50 | 18.50 | 18.50 | 18.50 | 18.50 | 18.50 | 18.50 | 18.50 |
| (d) SLES ⁽²⁾ | 30.00 | 30.00 | 30.00 | 30.00 | 30.00 | 30.00 | 30.00 | 30.00 |
| (c) 1-methyl-propanediol | 10.00 | 10.00 | 10.00 | 10.00 | 10.00 | 10.00 | 10.00 | 10.00 |
| (f) silicone based antifoam f1 ⁽³⁾ | 0.01 | 0.15 | 0.10 | 0.05 | 0.15 | 0.05 | 0.05 | 0.10 |
| | (f3) | | | | | | | |
| (g) fatty acid ester g2 ⁽⁴⁾ | 1.00 | 1.00 | 1.00 | 2.00 | 1.00 | 2.00 | 1.00 | 1.00 |
| | | | | | (g4) | (g4) | (g4) | (g4) |
| (i) water⁽⁵⁾ | ad 100 | ad 100 | ad 100 | ad 100 | ad 100 | ad 100 | ad 100 | ad 100 |

| Example No. | 12 | 28 | 29 | 30 | 31 | 25 | 26 |
|---|---|---|---|---|---|---|---|
| (a) Glufosinate-ammonium (a.i.) | 18.50 | 18.50 | 18.50 | 18.50 | 18.50 | 18.50 | 18.50 |
| (d) SLES ⁽²⁾ | 30.00 | 30.00 | 30.00 | 30.00 | 30.00 | 30.00 | 30.00 |
| (c) 1-methyl-propanediol | 10.00 | 10.00 | 10.00 | 10.00 | 10.00 | 10.00 | 10.00 |
| (f) silicone based antifoam f1 ⁽³⁾ | 0.01 | 0.15 | 0.05 | 0.05 | 0.10 | 0.05 | 0.05 |
| | (f3) | | | | | | |
| (g) fatty acid ester (g3) ⁽⁴⁾ | 1.00 | 1.00 | 2.00 | 1.00 | 0.50 | 2.00 | 1.00 |
| | | | | | | (g5) | (g5) |
| (i) water⁽⁵⁾ | ad 100 | ad 100 | ad 100 | ad 100 | ad 100 | ad 100 | ad 100 |

| | | | | | | | Commercial |
|---|---|---|---|---|---|---|---|
| Example No. | RF1⁽¹⁾ | RF2 | RF3 | RF4 | RF5 | RF6 | product |
| (a) Glufosinate-ammonium (a.i.) | 18.50 | 18.50 | 18.50 | 18.50 | 18.50 | 18.50 | 18.50 |
| (d) SLES ⁽²⁾ | 30.00 | 30.00 | 30.00 | 30.00 | 30.00 | 30.00 | 30.00 |
| (c) 1-methyl-propanediol | 10.00 | 10.00 | 10.00 | 10.00 | 10.00 | 10.00 | 10.00 |
| (f) silicone based antifoam ⁽³⁾ | 0.15 | 0.15 | 0.15 | | | | |
| | (f1) | (f2) | (f3) | | | | |
| (g) fatty acid ester g4 ⁽⁴⁾ | | | | 1.00 | 1.00 | 1.00 | |
| | | | | (gl) | (g2) | (g3) | |
| Perfluorinated antifoam | | | | | | | 0.09 |
| Mixture of perfluoroalkyl | | | | | | | |
| phosphonic acid (PFPA) and | | | | | | | |
| perfluoroalkyl phosphinic acid | | | | | | | |
| (PFPIA) | | | | | | | |
| (i) water⁽⁵⁾ | ad 100 | ad 100 | ad 100 | ad 100 | ad 100 | ad 100 | Add 100 |

Abbreviations and indizes in Table 1: see after Table 1
Abbreviations in Table 1:
a.i. amount based on active ingredient,
⁽¹⁾ no mark = according to invention/RF = reference
⁽²⁾ Sodium laurylether sulfate
⁽³⁾ f1 = SAG 1572
f2 = SAF 184
f3 = FOAM-CLEAR ARRAPRO S
⁽⁴⁾ g1 = 3,5,5-trimethylhexyl 3,5,5-trimethylhexanoate,
g2 = 2-ethylhexylpalmitat,
g3 = 2,3,4-tris(2-ethylhexanoyloxy)butyl 2-ethylhexanoate,
g4 = Neopentyl glycol diethylhexanoate,
g5 = 1,3-bis[(2-ethylhexanoyl)oxy]propan-2-yl 2-ethylhexanoate.
⁽⁵⁾the amount of water is indicated as ad 100% and also includes small amounts of nonaqueous coconstituents that may be present in certain components employed, such as colorants, preservatives, etc.

### Persistency Foam Test According to CIPAC MT 47.3

Transfer approx. 180 mL of CIPAC standard water D or softer water including 40 ppm minerals to the measuring cylinder standing on a balance.

Weigh and add 2.2 g, (2 ml, density 1.10 g/cm³) of SL formulation required to prepare a 200 mL dilution. Top up with CIPAC standard water D to 200 mL. Stopper the cylinder and invert it 30 times. Place the stoppered cylinder upright on the bench at room temperature and immediately start the stop watch. Read and record the height (mm) of foam from water surface after 10 seconds, 1 minute, 3 minutes, 12 minutes. Volume of foam was calculated by volume per 1 mm (ml/mm)

TABLE 5
(foam test)

| | Water Hardness: | | | | Water Hardness: | | | | Water Hardness: | | | |
|---|---|---|---|---|---|---|---|---|---|---|---|---|
| Reference/ | CIPAC D water (324 ppm) | | | | Soft water (40 ppm) | | | | Distilled water | | | |
| Example No. | 0.17 min | 1 min | 3 min | 12 min | 0.17 min | 1 min | 3 min | 12 min | 0.17 min | 1 min | 3 min | 12 min |
| RF-1 | | | | | 149 | 103 | 98 | 29 | | | | |
| RF-2 | | | | | 103 | 35 | 20 | 10 | | | | |
| RF-4 | | | | | 149 | 144 | 144 | 92 | | | | |
| RF-5 | | | | | 149 | 138 | 138 | 81 | | | | |
| RF-6 | | | | | 149 | 138 | 138 | 138 | | | | |
| RF-7 | | | | | 149 | 138 | 138 | 138 | | | | |
| Commercial | | | | | 143 | 143 | 108 | 2 | | | | |
| product | | | | | | | | | | | | |
| EX-1 | | | | | 163 | 150 | 113 | 44 | | | | |
| EX-2 | | | | | 138 | 19 | 19 | 13 | | | | |
| EX-3 | | | | | 106 | 6 | 6 | 6 | | | | |
| EX-4 | 81 | 10 | 8 | 7 | 81 | 7 | 6 | 5 | | | | |
| EX-5 | 97 | 9 | 8 | 6 | 63 | 5 | 5 | 5 | | | | |
| EX-6 | | | | | 80 | 7 | 6 | 5 | | | | |
| EX-7 | 51 | 6 | 5 | 5 | 132 | 17 | 17 | 12 | 63 | 7 | 7 | 7 |
| EX-8 | | | | | 126 | 17 | 17 | 12 | | | | |
| EX-9 | 14 | 3 | 3 | 2 | | | | | | | | |
| EX-10 | 7 | 2 | 2 | 2 | | | | | | | | |
| EX-11 | | | | | 34 | 3 | 3 | 2 | | | | |
| EX-12 | 75 | 2 | 2 | 2 | | | | | | | | |
| EX-13 | | | | | 63 | 3 | 3 | 3 | | | | |
| EX-14 | 132 | 126 | 121 | 81 | 132 | 126 | 126 | 48 | | | | |
| EX-16 | 57 | 7 | 7 | 6 | 32 | 6 | 5 | 5 | | | | |
| EX-17 | 91 | 14 | 10 | 8 | | | | | | | | |
| EX-18 | 35 | 5 | 5 | 3 | | | | | 35 | 5 | 3 | 2 |
| EX-21 | 114 | 21 | 11 | 7 | | | | | | | | |
| EX-22 | 68 | 5 | 5 | 3 | | | | | 63 | 7 | 6 | 6 |
| EX-23 | 144 | 86 | 46 | 23 | | | | | | | | |
| EX-24 | 119 | 23 | 10 | 5 | | | | | | | | |
| EX-25 | 35 | 5 | 5 | 5 | | | | | 17 | 3 | 3 | 0 |
| EX-26 | 149 | 132 | 58 | 35 | | | | | | | | |
| EX-28 | 114 | 3 | 3 | 3 | 74 | 2 | 2 | 2 | | | | |
| EX-29 | 103 | 7 | 7 | 6 | | | | | 35 | 3 | 3 | 1 |
| EX-30 | 149 | 115 | 92 | 35 | | | | | | | | |
| EX-31 | | | | | 102 | 4 | 4 | 3 | | | | |

1. A defoaming composition for an agrochemical formulation comprising:
1) a silicone based defoamer, and
2) a fatty acid ester (carboxylic ester) with a C8 to C16 acid moiety.

2. The defoaming composition for an agrochemical formulation according to claim 1, wherein the ratio of 1) to 2) is from 1:1000 to 1:8.

3. The defoaming composition for an agrochemical formulation according to claim 1, wherein the ratio of 1) to 2) is from 1:50 to 1:10.

4. The defoaming composition for an agrochemical formulation according to claim 1, wherein the silicone based defoamer is selected from the group of linear polymethyldisiloxanes.

5. The defoaming composition for an agrochemical formulation according to claim 4, wherein the silicone based defoamer is selected from the group of linear polymethyldisiloxanes in emulsion.

6. The defoaming composition for an agrochemical formulation according to claim 4, wherein the silicone based defoamer comprises silica.

7. The defoaming composition for an agrochemical formulation according to claim 4, wherein the defoamer has an average dynamic viscosity, measured at 25° C., in the range from 1000 to 8000 mPas (mPas=millipascal-second).

8. The defoaming composition for an agrochemical formulation according to claim 1, wherein said at least one fatty acid ester 2) contains comprises or may be obtained from
a1) a carboxylic monoacid moiety and a monoalcohol moiety and/or
b1) at least one carboxylic monoacid moiety and a polyalcohol moiety
wherein said monoalcohol moiety is a branched, linear, cyclic, acyclic or partially cyclic, saturated or partially unsaturated C1-C24 monoalcohol moiety, optionally
wherein said polyalcohol moiety is a branched, linear, cyclic, acyclic or partially cyclic, saturated or partially unsaturated di-, tri-, tetra-, penta- and/or hexavalent C2-C20 polyalcohol moiety; and
wherein said carboxylic monoacid moiety is a branched, linear, cyclic, acyclic or partially cyclic, saturated or partially unsaturated C8-C16 carboxylic monoacid moiety, preferably optionally C8-C9 carboxylic monoacid moiety optionally carrying at least one OH functionality.

9. The defoaming composition for an agrochemical formulation according to claim 8, wherein the acid moiety is a C8-C9 acid moiety.

10. The defoaming composition for an agrochemical formulation according to claim 1, wherein the alcohol moiety of the fatty acid ester is a monoalcohol.

11. The defoaming composition for an agrochemical formulation according to claim 10, wherein the monoalcohol is selected from the group consisting of methanol, ethanol, 1-propanol, 2-propanol, 1-butanol, 2-butanol, isobutanol, tert-butanol, 1-pentanol, 1-hexanol, 1-heptanol, 2-ethylhexan-1-ol, 3,5,5-trimethylhexan-1-ol, 3,4,4-trimethylpentan-1-ol, capryl alcohol, pelargonic alcohol, isononyl alcohol, capric alcohol, undecanol, lauryl alcohol, and mixtures thereof.

12. The defoaming composition for an agrochemical formulation according to claim 1, wherein the alcohol moiety of the fatty acid ester is a polyalcohol.

13. The defoaming composition for an agrochemical formulation according to claim 10, wherein the polyalcohol is selected from the group consisting of glycol, 1,3-propandiol, 1-4-butandiol, 1,5-pentandiol, 1,6-hexandiol, cyclohexan-1,2-diol, isosorbid, 1,2-propandiol, neopentylglycol, glycerol, trimethylolpropane, erythritol, pentaerythritol and sugar alcohols according to the formula HOCH₂(CHOH)ₙCH₂OH and mixtures thereof.

14. A low foam crop protectant composition comprising the defoaming composition according to claim 1 comprising:
(a) one or more water-soluble active crop protectant ingredients (type (a) active ingredients),
(b) optionally one or more water-insoluble active crop protectant ingredients (type (b) active ingredients),
(c) optionally one or more polar organic solvents,
(d) one or more anionic surfactants,
(e) optionally, nonionic, cationic and/or zwitterionic surfactants,
(f) one or more silicone-based defoamers 1)
(g) fatty acid ester 2)
(h) optionally one or more formulation assistants, and
(i) water,
wherein the ratio of f (silicone-based defoamer 1)) to g) (fatty acid ester 2)) is from 1:1000 to 1:8.

15. The crop protectant composition as claimed in claim 14 comprising
(a) 1% to 40%, optionally 2% to 30% and optionally 5% to 20% by weight of one or more water-soluble active crop protectant ingredients (type (a) ingredients),
(b) 0 to 40%, optionally 0 to 20% and optionally 0 to 10% by weight of one or more water-insoluble active crop protectant ingredients (type (b) ingredients),
(c) 0% to 50%, optionally 2 to 30%, optionally 5 to 20%, and optionally 5 to 15% by weight of one or more polar organic solvents,
(d) 1% to 80%, optionally 5% to 70%, optionally 6% to 60%, and optionally 20 to 40% by weight of one or more anionic surfactants,
(e) 0 to 20%, optionally 0 to 15%, by weight of one or more nonionic, cationic and/or zwitterionic surfactants,
(f) 0.0005% to 2%, optionally 0.005% to 1% and optionally 0.01% to 0.25% by weight of the, optionally silica-containing, defoamer
(g) 0.01% to 20%, optionally 0.05% to 10% and optionally 0.5% to 5.0% by weight of fatty acid ester
(h) 0 to 30%, optionally 0 to 20% and optionally 0.1 to 15% by weight of one or more formulation assistants,
(i) water to add up to 100%,
wherein the ratio of f (silicone-based defoamer 1)) to g) (fatty acid ester 2)) is from 1:1000 to 1:8.

16. A process for preparing a crop protectant composition as defined in claim 14, which comprises mixing components (a) to (g) and, optionally, further components present in the formulation with water (component (h)).

17. A product comprising the defoaming composition of claim 1 for preparing low foam crop protection formulation.
